(19) United States
(12) Patent Application Publication
(10) Pub. No.: US 2021/0335057 A1
(43) Pub. Date: Oct. 28, 2021

(54) METHOD AND SYSTEM FOR PARKING SPOT EXCHANGE

(71) Applicants: John Galasso, Centerport, NY (US); John Herbert Galasso, Centerport, NY (US)

(72) Inventors: John Galasso, Centerport, NY (US); John Herbert Galasso, Centerport, NY (US)

(21) Appl. No.: 17/237,029

(22) Filed: Apr. 21, 2021

Related U.S. Application Data
(60) Provisional application No. 63/013,616, filed on Apr. 22, 2020.

(51) Int. Cl. G07B 15/02

(52) U.S. Cl. CPC G07B 15/02; G06Q 20/14

(57) ABSTRACT

A method comprising: receiving a request for a parking spot by a driver in a vehicle; identifying a set of parameters associated with the driver and the vehicle; generating a set of parking spots based on the vehicle and the driver sets of parameters which are available; receiving a request for a parking spot selected the driver, wherein the request includes a fee, the address of the spot, a time for an exchange, and the driver and vehicle set of parameters; and indicating that the driver is at a predetermined location based on the parking spot and confirming that a parked user is in a parked vehicle in the spot, and confirming the identity of the driver and the parked vehicle driver; and processing that the driver has acquired the parking spot and processing a fee.

### CROSS-REFERENCE TO RELATED APPLICATIONS

This application is a continuation-in-part (and claims the benefit of priority under 35 USC 120) of U.S. application No. 63/013,616 filed Apr. 22, 2020. The disclosure of the prior applications is considered part of (and is incorporated by reference in) the disclosure of this application.

### BACKGROUND

This disclosure relates generally locating parking spots, and more specifically to a method, computer program and computer system for exchanging one's parking spot with another for a fee.

Anyone who has circled a city block in a densely populated area endlessly in search of on street parking knows how frustrating finding parking is. You're at the mercy of chance, and your only options are hoping you'll get lucky or paying for parking at an expensive parking garage. Either way, your final parking spot might be located far from your destination.

Finding a parking spot for a vehicle may be a hard task. In densely populated areas, or where on-street parking is sparse, a driver may rely on luck, knowledge of unfamiliar parking spots, or simply waste time searching for a parking spot that becomes available.

One strategy of some drivers is to wait in certain locations in the hope of seeing another driver walking to her car and exiting a near-by parking. Another strategy is to continue driving until a parking spot is found. In either way, the drivers may prefer to search for the parking in a location that is relatively close (e.g., within a reasonable walking distance) from their target destination. In many cases, a driver that did not find a parking spot would give up and prefer to search for a paid parking spot instead of spending more time searching for free or cheap parking.

In most metropolitan cities, it is difficult to find street corner parking space close to where a driver needs to be. Most often drivers who have been circling around the vicinity of where they need to be in search of a parking space, eventually give up and opt for parking in a parking structure for a high hourly rate with a minimum required number of hours charged regardless of if they just need a fraction of an hour parking to accomplish their business.

There are software applications available, where a driver can use their smart phone or an application on their vehicle computer, which provides the driver with addresses of parking lots and parking structures proximate to business centers. However, the location of these parking facilities is fixed, and they are not always a convenient place both financially and where they are located as for where the driver needs to conduct her business.

In general, a majority of drivers tend to prefer a street parking space close to where they need to be, which is preferably free of charge, or if they need to pay for parking on the street, they can limit the charges to just the duration that they need to finish their business. However, due to nature of street parking where it is based on a first come first to occupy the available parking space it is difficult to arrange for a street parking within a specific time period that works with a potential business appointment. As such a driver who wishes to be at a meeting in a certain time usually cannot depend on finding a street parking space in a timely manner, and either has to allocate a substantial time for searching for and finding a street parking space well ahead of her meeting time or has to restore to parking in the closest parking facility with a high hourly charge and then walk the distance to where the meeting is taking place.

Therefore, it is desired for a method, computer program, or computer system to allow for those who are currently using a parking spot but are planning to leave the spot to present the opportunity to others to exchange the parking spot.

### SUMMARY

In a first embodiment, the present invention is a computer-implemented method comprising: receiving, by one or more processors, a request for a parking spot by a driver in a vehicle; identifying, by the one or more processors, a set of parameters associated with the driver and the vehicle; generating, by the one or more processors, a set of parking spots based on the vehicle and the driver sets of parameters which are available; receiving, by the one or more processors, a request for a parking spot selected the driver, wherein the request includes a fee, the address of the spot, a time for an exchange, and the driver and vehicle set of parameters; and indicating, by the one or more processors, that the driver is at a predetermined location based on the parking spot and confirming that a parked user is in a parked vehicle in the spot, and confirming the identity of the driver and the parked vehicle driver; and processing, by the one or more processors, that the driver has acquired the parking spot and processing a fee and updating the list of the set of parking spots based on updated availability of the set of parking spots.

In a second embodiment, the present invention is a computer program product for exchanging a parking spot between two drivers, the computer program product comprising: a computer non-transitory readable storage medium having program instructions embodied therewith, the program instructions executable by a computing device to cause the computing device to; receiving a request for an available parking spot; identifying a driver's profile details, wherein a vehicle is associated with the driver's profile; manipulating a map on a user interface with a set of parking spots based on the driver's profile details; receiving a selection of a parking spot; processing the exchange of the parking spot between the driver and a parked driver; and approving that the driver has successful parked their vehicle in the parking spot, and updating the set of parking spots.

In a third embodiment, the present invention is a system for exchanging a parking spot, the system comprising: a CPU, a computer readable memory and a computer non-transitory readable storage medium associated with a computing device; program instructions to receive a request for an available parking spot; program instructions to identify a driver desired location and set of vehicle information; program instructions to manipulating a map on a user interface with a set of parking spots based on the driver desired location, the vehicle information, wherein the set of parking spots are parking spots which are available for the driver; program instructions to receiving a selection of a parking spot; program instructions to initiate the exchange of the selected parking spot, wherein a set of information is exchanged between the driver and a parked driver; and program instructions to process the exchange and approve that the driver has successful parked their vehicle in the parking spot, wherein the money is exchanged and updating the set of parking spots.

### BRIEF DESCRIPTION OF THE DRAWINGS

The disclosure can be better understood with reference to the following detailed description taken in conjunction with the accompanying drawings which illustrate disclosed embodiments, but which are not necessarily drawn to scale. Wherever possible, the same reference numbers will be used throughout the drawing(s) and accompanying written description to refer to the same or like part, wherein:

FIG. 1 depicts a block diagram depicted a computing environment, in accordance with one embodiment of the present invention.

FIG. 2 depicts a block diagram depicting a computing environment, in accordance with one embodiment of the present invention.

FIG. 3 depicts a flowchart of the operational steps taken by a program to locate and exchange a parking spot within the computing environment of FIG. 1, in accordance with one embodiment of the present invention.

FIG. 4 depicts an image of a parking exchange user interface spot selection page, in accordance with one embodiment of the present invention.

FIG. 5 depicts an image of a selected parking spot page, in accordance with one embodiment of the present invention.

FIG. 6 depicts an image of a parking exchange user interface spot selection page, in accordance with one embodiment of the present invention.

### DETAILED DESCRIPTION

Disclosed embodiments will now be described more fully hereinafter with reference to the accompanying drawings, in which some, but not all of the disclosed embodiments are shown. Several different embodiments are provided and should not be construed as limiting the application of the disclosure to the details of construction and arrangement of the components or method of use set forth in the following description or illustrated in the following drawings as to the embodiments set forth herein. Rather, these embodiments are provided so that this disclosure will be thorough and fully convey the scope of the disclosure to those skilled in the art.

The present invention allows people to locate a parking spot without the hassle of having to search multiple streets to find an available spot. This provides both a time savings, cost savings, and environmental benefit to people in densely populated areas. With the ability for people who are parked and wanting to offer their spot or with the knowledge that they will no longer need the spot within a certain time frame, they are able to offer their spot to other users. This peer-to-peer exchange allows a parking user to gain an advantage of knowing where a spot is, when it will be available, and to facilitate a smooth transfer of the spot between the parties.

The present invention generally relates to parking space selection systems, and more particularly, to the selection of parking spaces based on parking space attributes, driver preferences, and vehicle information. Further, navigation directions can be provided to direct the driver to the selected spot based on current traffic and/or predictive traffic patterns existing within the parking facility. Advantageously, selection of parking spaces can be individualized for specific drivers and vehicles, and the driver can be efficiently directed to a selected parking space, thereby saving the driver substantial amounts of time and fuel.

As described herein, existing systems do not solve the technical problem of having a user who has a spot offer this spot to a user looking for a spot and assist in the timing of the exchange and the actual exchange of the spot.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects may generally be referred to herein as a “circuit,” “module”, or “system.” Furthermore, aspects of the present invention may take the form of a computer program product embodied in one or more computer readable medium(s) having computer readable program code/instructions embodied thereon.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowcharts and block diagrams in the Figures illustrate the architecture, functionality, and operation of possible implementations of systems, methods, and computer program products according to various embodiments of the present invention. In this regard, each block in the flowcharts may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the flowchart illustrations, and combinations of blocks in the flowchart illustrations, can be implemented by special purpose hardware-based systems that perform the specified functions or acts or carry out combinations of special purpose hardware and computer instructions.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

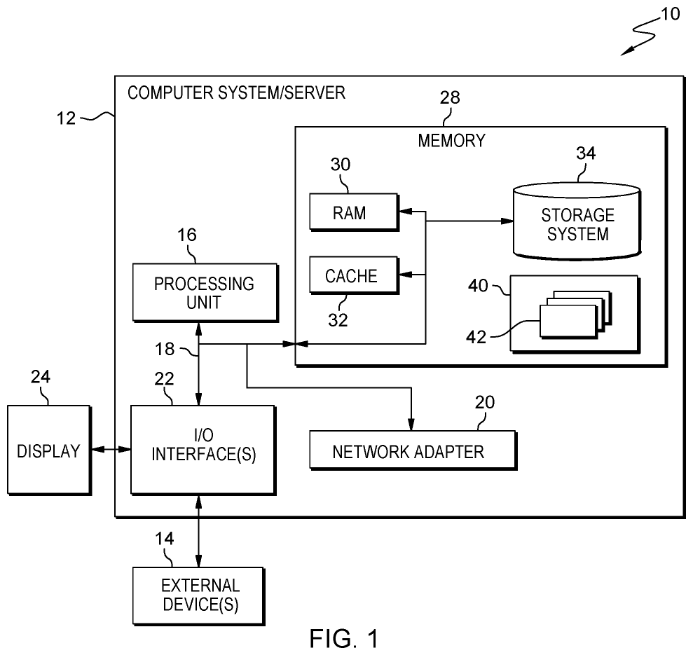

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purposes or special purpose computing system environments or configurations. Examples of well-known computing systems, environments, and/or configurations that may be suitable for use with computer system/server 12 include, but are not limited to, cellular phone, mobile phone, smart phone, personal computer systems, hand-held, and distributed cloud computing environments that include any of the above systems or devices, and the like.

Computer system/server 12 may be described in the general context of computer system executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random-access memory (RAM) 30 and/or cache memory 32.

Computer system/server 12 may further include other removable/non-removable, volatile/non-volatile computer system storage media. By way of example only, storage system 34 can be provided for reading from and writing to a nonremovable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to microcode, device drivers, redundant processing units, external disk drive arrays, RAID systems, tape drives, and data archival storage systems, etc.

FIG. 1, the Program/utility 40 may include one or more program modules 42 that generally carry out the functions and/or methodologies of embodiments of the invention as described herein.

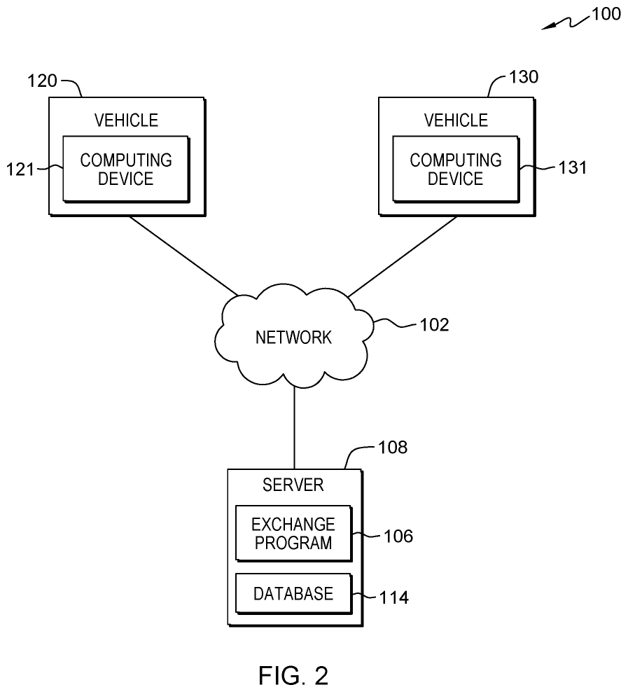

FIG. 2 depicts a block diagram of a computing environment 100 in accordance with one embodiment of the present invention. FIG. 2 provides an illustration of one embodiment and does not imply any limitations regarding the environment in which different embodiments maybe implemented. In the depicted embodiment, computing environment 100 includes network 102, parking vehicle 120, parked user vehicle 130 and server 104. Computing environment 100 may include additional servers, computers, or other devices not shown.

Network 102 may be a local area network (LAN), a wide area network (WAN) such as the Internet, any combination thereof, or any combination of connections and protocols that can support communications between parking vehicle 120, parked user vehicle 130 and server 104 in accordance with embodiments of the invention. Network 102 may include wired, wireless, or fiber optic connections.

Parking vehicle 120 identifies the vehicle which the person looking for a parking spot (space or the like) is driving or in. The type of vehicle (e.g., SUV, sedan, truck, etc.) is known and identifiable by the driver/operator of the software.

Computing device 120 may be a smart phone, mobile phone, laptop, or any other electronic device or computing system capable of processing program instructions and receiving and sending data via network 102. In the depicted embodiment, computing device 120 is used by the driver of the parking vehicle 120 and is able to communicate with the server 104 and the computing device 130 via network 102. Computing device 120 may include components, as depicted and described in further detail with respect to FIG. 1.

Parked vehicle 130 identifies the vehicle which is in a parking spot and is willing, scheduled, or able to offer their spot to the parking vehicle 120. The type of vehicle (e.g., SUV, sedan, truck, etc.) is known and identifiable by the driver/operator of the software.

Computing device 130 may be a smart phone, mobile phone, laptop, or any other electronic device or computing system capable of processing program instructions and receiving and sending data via network 102. In the depicted embodiment, computing device 130 is used by the driver of the parked vehicle 130 and is able to communicate with the server 104 and the computing device 120 via network 102. Computing device 130 may include components, as depicted and described in further detail with respect to FIG. 1.

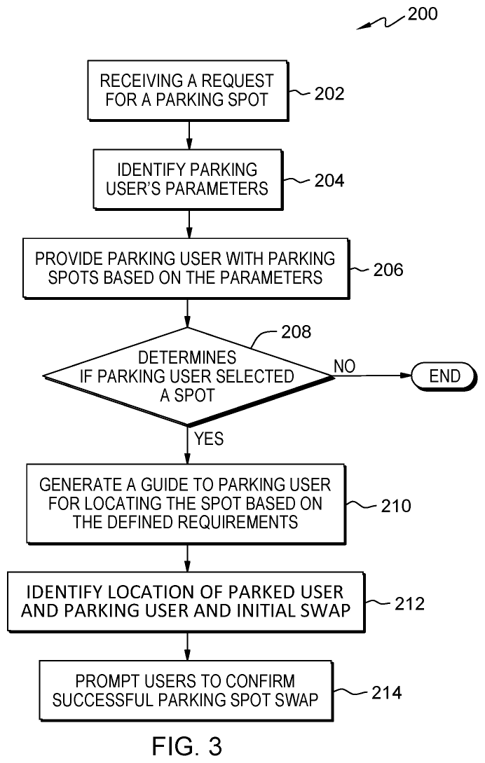

Server 108 may be a management server, a web server, or any other electronic device or computing system capable of processing program instructions and receiving and sending data. In other embodiments server 108 may be a laptop computer, tablet computer, netbook computer, personal computer (PC), a desktop computer, or any programmable electronic device capable of communicating via network 102. In one embodiment, server 108 may be a server computing system utilizing multiple computers as a server system, such as in a cloud computing environment. In one embodiment, server 108 represents a computing system utilizing clustered computers and components to act as a single pool of seamless resources. In the depicted embodiment database 114 is located on server 108. Server 108 may include components, as depicted and described in further detail with respect to FIG. 3.

Exchange program 110 provides for the securing of a parking spot for the parking vehicle 120 from the parked vehicle 130, wherein the parking vehicle 120 requests a spot and once a spot is selected, the parked vehicle 130 within that spot exchanges the spot with the parking vehicle 120. This exchange is facilitated and monitored by the exchange program 110. In the depicted embodiment, Exchange program 110 utilizes network 102 to access the computing devices 121 and 131 and communicates with database 114. In one embodiment, Exchange program 110 resides on sever 108. In other embodiments, Exchange program 110 may be located on the computing devices 121 and 131 or another server or computing device.

Database 114 may be a repository that may be written to and/or read by Neurological program 110, evaluation function 112. Information gathered from structured data source 110 and/or unstructured data source 112 may be stored to database 114. Such information may include previous scores, audio files, textual breakdowns, facts, events, and contact information. In one embodiment, database 114 is a database management system (DBMS) used to allow the definition, creation, querying, update, and administration of a database(s). In the depicted embodiment, database 114 resides on patient computing device 104. In other embodiments, database 114 resides on another server, or another computing device, provided that database 114 is accessible to Neurological program 110 and evaluation function 112.

FIG. 3 shows flowchart 200 depicting a method according to the present invention. The method(s) and associated process(es) are now discussed.

The method provides for the exchange of an occupied parking spot in response to a request from a user looking for a parking spot. This exchange may include a fee, and at which time the fee is required for the parked user to relinquish the spot to the parking user.

The program(s) described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

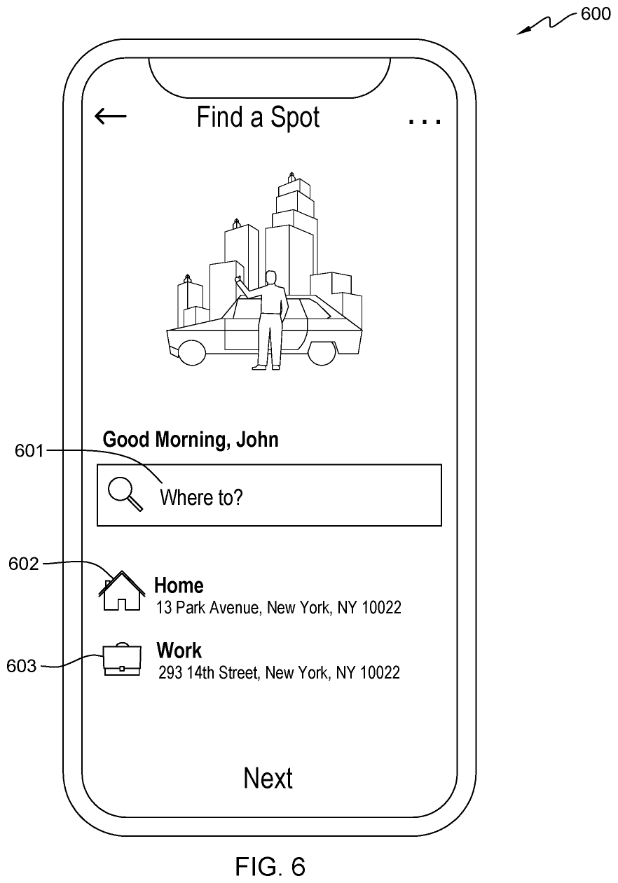

In step 202, the parking user requests a parking spot through a computing device and through the exchange program 110. This request is tied to the computing device of the parking user to collect both time, and location information of the parking user. In some instances, the parking user makes a request to park within a defined area, at a defined location, or a broader setting where they set forth the boundaries of where they wish to park and time frame in which they would like to park. FIG. 6 depicts an embodiment of a user interface 600. The user is able to input a destination 601 or select a predetermined (or previously entered) destination 602 or 603.

In some instances, the user accesses a map which shows all the available spaces at that instance, and times indicating when other spots will become available to exchange or available to take and the price for the spot. The map is interactive and can be zoomed in and out. In some instances when the driver is approaching the selected spot the map will steadily zoom into the area between the driver and the selected spot and increase the detail of the environment to assist the driver and making it to the desired location. These are all updated in real-time to assist the user in locating the ideal spot. Additionally, parking spots that were once occupied but are now not, may appear to the parking user. These spots are warnings as there is no information to determine a new vehicle as taken the spot but gives the user an opportunity to get a free parking spot. In some instances, spots that have restrictions (handicap and the like) are marked accordingly (or can be disabled based on if the user qualifies) to inform the user of the requirements for this spot to avoid being ticketed or towed.

In step 204, the exchange program 110 identifies the parking user's location, and parameters. The location, which is also related to the time of request (both when the request is made and when the spot is desired) are indicated in the request. The geographical information provides the exchange program 110 with the spots available to the parking user. The exchange program 110 identifies the totality of spaces available to the parking user within a maximum distance from the geographical location by locating all of the parked user's computing devices which are using the exchange program 110. Once all the spots are located, the exchange program 110 sorts of these spots based on the parking user's parameters. The parameters maybe limited based on the user profile or applied defaults based on the information provided by the user and the minimum amount of information necessary to facilitate the exchange. The parameters may include distance from present location maximum, distance from destination maximum, space size, vehicle size, handicap requirements, availability of spot, length of time spot is required, price, and the like. The parking user's parameters are based on the identification of the parking user's profile. The user may select minimums or through a series of user interface selection screens or pages may make these selections. In some embodiments, the user has a profile that includes all the driver's information and vehicle information.

If no spots are available, the user is provided with a notice increase the range or criteria to find a spot. This may be where the user has a fee limit, or a radius limit which is below the nearest spot.

In step 206, the exchange program 110 provides the parking user with the parking spots which meet the parking user requirements/parameters and allows the parking user to make a selection as to the spot they wish to take. This may include a fee associated with the exchange that would be provided to the parked user. Based on time of day, demand, location, density of cars, events, and the like the price of fee is dynamic and fluctuates to accommodate these environmental changes. In some instances, the parked user may be able to set a price manually for the spot, the parking user may make a request for a fee for the spot, or other means to establish the price for the spot. These spots are provided to the user through a user interface. Once a selection of spot is made (Determination 208), the exchange program 110 provides the parking user and the parked user with the necessary information to facilitate the exchange. In some embodiments, a queue of parking users may request a single spot. This can result in an exchange of bids for the spot where the highest bid wins, but also provides for a user to be assigned the spot if a user higher in the queue cancels. Once the user selects a spot, the spot will be removed from another user's interface. In some embodiments, if a spot is cancelled, being cancelled, or one party is failing to complete the exchange, the spot may reappear or appear in a different version than the available spots to alert users of a spot potentially becoming available.

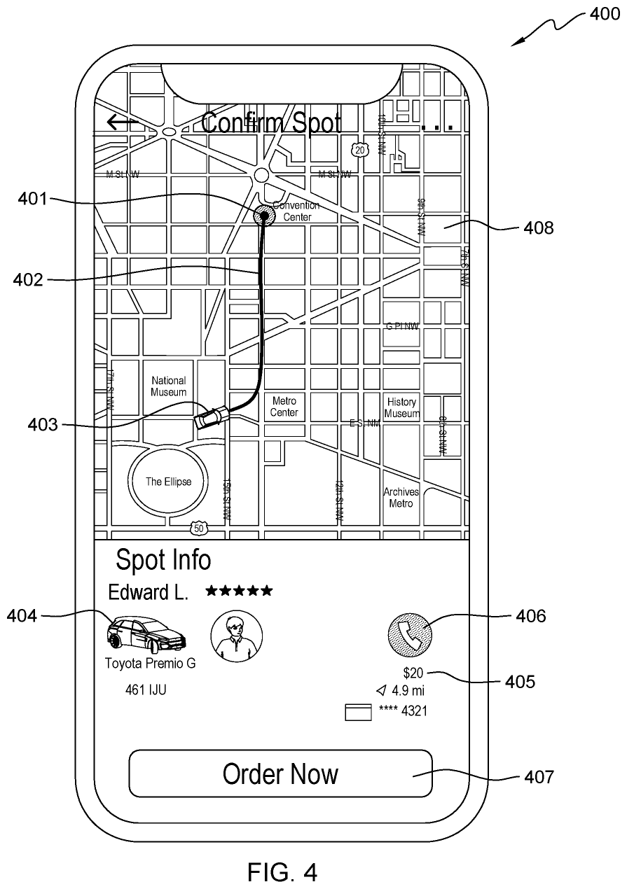

The parking user is provided a detailed map and set of directions to reach the spot, and to be positioned on the correct side of the road and in the correct position (in front of or behind) the parked user. This will provide for the smoothest exchange, and the smallest opportunity for a third party to interfere with the exchange. A timer is also provided to the parking user to confirm that they will be at the desired location at the correct time. This timer is adjusted based on traffic, and if the parked user is in the vehicle or approaching the vehicle. As both timers reach zero, the parking user is in the desired spot and the parked user is in their vehicle. FIG. 4 depicts an embodiment of a user interface 400 where the user's location 403 is shown, the required route 402 to reach the spot 401 is show and needs to be followed. In some embodiments all available spots are identified as spots across the map. The map 408 shows the area to give the user assistance in determining a spot they want based on a desired location. The spot information is shown giving the vehicle 404 that is in the spot with identifying information and an image of the driver, a direct communication means 406 to call or text the driver. The cost 405 which the parker paid to reserve the spot and their payment method. Icon 407 allows the user to purchase the spot from the user. In some embodiments, the route 402 is adjustable and dynamic based on traffic or other conditions.

The parked user is provided with confirmation that their spot is desired and that an exchange is to occur. This will provide the parked user with the desired time to be in the vehicle to facilitate the exchange and information related to the vehicle which will take the spot. This can include make, model, color, license plate number, and the like.

In step 210, exchange program 110 confirms that the vehicles are in the proper locations, through the receipt of information from the parking user and the parked user and the drivers/computing devices are where they are required to be geographically. Both the parking user, and the parked user confirm their location, and that the exchange is occur. At this time the parked user leaves the spot, and the parking user enters the spot. Once the parked user leaves the spot, the changes to the geographical information indicate the spot is now available. Once the parking user is in the spot, they confirm they have gained access to the spot and the exchange is completed. Once the exchange is complete, the exchange program 110 issues the fee to the parked driver and the commission fee. The fee for swapping the spot is based on a base fare, custom rates for specific areas, vehicle type, and number of parking spots available at that time. This may be accomplished by a photo taken with the computing device and analyzing the photo, manual entry by the user of the vehicle information, or a notification or selection of a button by the users.

In an embodiment, the users are able to communicate with one another through the program to confirm the parties are present and facilitate the exchange.

A flowchart depicting a business method of charging a commission fee for securing an available parking spot. In step 202 a parked driver occupies a spot, and the exchange program applies a value to that spot based on a variety of mentioned conditions. In some embodiments, the parked user can override the value with a lower price or higher price which is approved by the program. The spot is visible to users of the program and the availability of, and price of the spot are indicated.

In Step 204, a parking user requests the spot and agrees to the indicated price. The parking user proceeds with swapping the spot. If the swap is completed successfully, the parking user is charged the fee, and a portion of the fee is paid to the parked user. If the swap is unsuccessfully completed, based on the circumstances, the parked user or the parking user may be responsible for fees. For example, if the parking user fails to show at the proper time or place, they are charged a portion of the fee. If the parked user fails to show or release the spot to the parking user, the parked user is charged a portion of the fee.

In some instances, there may be issues, complications, or errors with the exchanges of the spot. With the inclusion of the timer, if the parking user is not at the spot within a certain time after the expiration of the time, the parked user is awarded a fee and is not required to release their spot or is able to release their spot without any repercussions from the parking user. If a parked user fails to be in the vehicle at the proper time, leaves to early (and the spot is taken by a third party) or leaves to late, they are charged a fee. In the instance where the spot is taken by a third party, the parking user is required to submit a photo of the vehicle, which is analyzed by the exchange program 110 to confirm that vehicle in the spot is not the parked user's vehicle.

If the parking user is not following the provided directions, they are warned of the possibility that the spot will not remain available to them, and if a certain time or distance from the spot is met, they forfeit the spot and release the parked user from having to meet at the desired time. If the parking user is not following the provided directions, they will be provided with new directions or provided a notification to indicate the cancellation of the exchange.

The user once parked is able to identify the spot as parked and assign a time frame which they will be in the spot, a tentative exiting time, or a window in which someone is able to see the spot as active. This allows the recently parked user to have a new parking user request the spot and continue the process of offering parking spots to users of the exchange program 110 and to get paid for their spot. In some instances, all vehicles which are incorporated into the program have an available or unavailable setting based on the user's preference to remain in the spot or open the spot up.

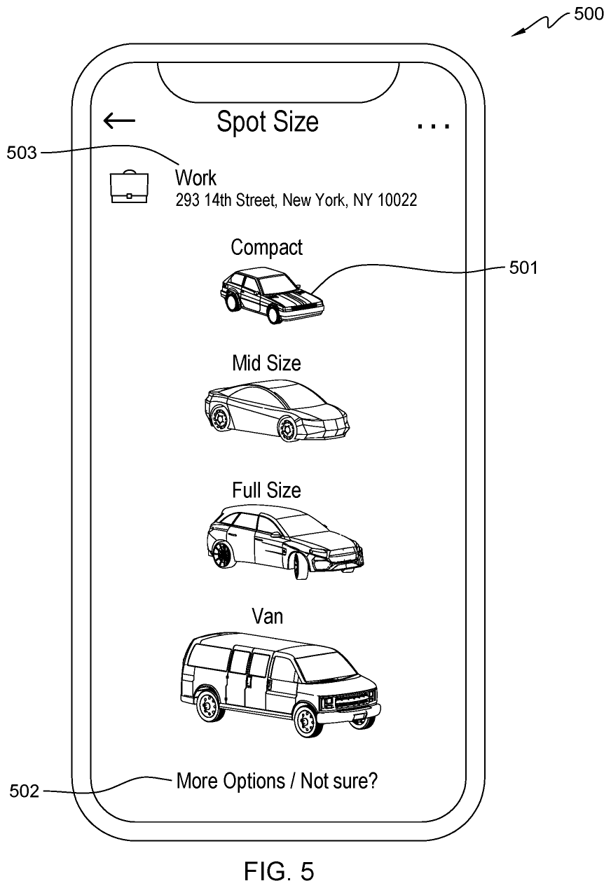

This information is relevant to confirm the identification of the parking user, and the vehicle type and information. The vehicle type (e.g., sedan, compact, electric, SUV, truck, van, etc.) affect the spots or locations which can/will be identified to the user to allow for the selection of a parking spot. FIG. 5 depicts an embodiment of a user interface 500 where the vehicle type 501 is show. This provides the user with a reference to how large of a space they need based on the vehicle they are driving. If the vehicle type or size, they are not listed or they need additional assistance they can use selection 502. This may include information related to the type of space (e.g., street, parking lot, garage, etc.) and additional vehicle sizes. The type of space may provide additional information for how the person will need to park, for example if it is street parking, they will have to parallel park and will need additional space before and after the vehicle to get in and out of the space. In some embodiments, the program is able to assist the driver with parking in the space by providing a visual of how to properly parallel park. Address 503 provides information about the area in which the driver wants to park and the available spaces (and vehicle sizes 501) which are within a predetermine vicinity of the destination.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Present invention: should not be taken as an absolute indication that the subject matter described by the term “present invention” is covered by either the claims as they are filed, or by the claims that may eventually issue after patent prosecution; while the term “present invention” is used to help the reader to get a general feel for which disclosures herein that are believed as maybe being new, this understanding, as indicated by use of the term “present invention,” is tentative and provisional and subject to change over the course of patent prosecution as relevant information is developed and as the claims are potentially amended.

The foregoing descriptions of various embodiments have been presented only for purposes of illustration and description. They are not intended to be exhaustive or to limit the present invention to the forms disclosed. Accordingly, many modifications and variations of the present invention are possible in light of the above teachings will be apparent to practitioners skilled in the art. Additionally, the above disclosure is not intended to limit the present invention. In the specification and claims the term “comprising” shall be understood to have a broad meaning similar to the term “including” and will be understood to imply the inclusion of a stated integer or step or group of integers or steps but not the exclusion of any other integer or step or group of integers or steps. This definition also applies to variations on the term “comprising” such as “comprise” and “comprises”.

Although various representative embodiments of this invention have been described above with a certain degree of particularity, those skilled in the art could make numerous alterations to the disclosed embodiments without departing from the spirit or scope of the inventive subject matter set forth in the specification and claims. Joinder references (e.g., attached, adhered, joined) are to be construed broadly and may include intermediate members between a connection of elements and relative movement between elements. As such, joinder references do not necessarily infer that two elements are directly connected and in fixed relation to each other. Moreover, network connection references are to be construed broadly and may include intermediate members or devices between network connections of elements. As such, network connection references do not necessarily infer that two elements are in direct communication with each other. In some instances, in methodologies directly or indirectly set forth herein, various steps and operations are described in one possible order of operation, but those skilled in the art will recognize that steps and operations may be rearranged, replaced or eliminated without necessarily departing from the spirit and scope of the present invention. It is intended that all matter contained in the above description or shown in the accompanying drawings shall be interpreted as illustrative only and not limiting. Changes in detail or structure may be made without departing from the spirit of the invention as defined in the appended claims.

Although the present invention has been described with reference to the embodiments outlined above, various alternatives, modifications, variations, improvements and/or substantial equivalents, whether known or that are or may be presently foreseen, may become apparent to those having at least ordinary skill in the art. Listing the steps of a method in a certain order does not constitute any limitation on the order of the steps of the method. Accordingly, the embodiments of the invention set forth above are intended to be illustrative, not limiting. Persons skilled in the art will recognize that changes may be made in form and detail without departing from the spirit and scope of the invention. Therefore, the invention is intended to embrace all known or earlier developed alternatives, modifications, variations, improvements and/or substantial equivalents.

What is claimed is:

1. A computer-implemented method comprising:
receiving, by one or more processors, a request for a parking spot by a driver in a vehicle;
identifying, by the one or more processors, a set of parameters associated with the driver and the vehicle;
generating, by the one or more processors, a set of parking spots based on the vehicle and the driver sets of parameters which are available;
receiving, by the one or more processors, a request for a parking spot selected the driver, wherein the request includes a fee, the address of the spot, a time for an exchange, and the driver and vehicle set of parameters; and
indicating, by the one or more processors, that the driver is at a predetermined location based on the parking spot and confirming that a parked user is in a parked vehicle in the spot, and confirming the identify of the driver and the parked vehicle driver; and
processing, by the one or more processors, that the driver has acquired the parking spot and processing a fee and updating the list of the set of parking spots based on updated availability of the set of parking spots.

2. The computer-implemented method of claim 1, wherein the set of parking spots are displayed on a map.

3. The computer-implemented method of claim 1, wherein the fee is dynamic based on a set of variables.

4. The computer-implemented method of claim 1, wherein the set of parameters associated with the vehicle include the vehicle type.

5. The computer-implemented method of claim 4, further comprising, analyzing, by the one or more processors, parking spots based on the vehicle type and a parking spot type, wherein a parking style is associated with the parking spot type.

6. The computer-implemented method of claim 1, providing, by the one or more processors, an image of the parked vehicle in a user interface.

7. The computer-implemented method of claim 1, wherein a set of directions are provided to the parking spot based on the driver's location.

8. The computer-implemented method of claim 1, further comprising, adjusting, by the one or more processors, the set of parking spots based on a preferred parking spot type.

9. A computer program product for exchanging a parking spot between two drivers, the computer program product comprising:
a computer non-transitory readable storage medium having program instructions embodied therewith, the program instructions executable by a computing device to cause the computing device to;
receiving a request for an available parking spot;
identifying a driver's profile details, wherein a vehicle is associated with the driver's profile;
manipulating a map on a user interface with a set of parking spots based on the driver's profile details;
receiving a selection of a parking spot;
processing the exchange of the parking spot between the driver and a parked driver; and
approving that the driver has successful parked their vehicle in the parking spot, and updating the set of parking spots.

10. The computer program product of claim 9, further comprising, presenting a map showing available parking spots.

11. The computer program product of claim 9, further comprising, receiving data related to parking spots which become available.

12. The computer program product of claim 9, calculating the size of a space based on a parking spot type and a vehicle type;

13. The computer program product of claim 9, generating a route from the driver's present position to the selected parking spot;

14. The computer program product of claim 13, monitoring the driver's location as they travel to the selected parking spot.

15. A system for exchanging a parking spot, the system comprising:
a CPU, a computer readable memory and a computer non-transitory readable storage medium associated with a computing device;
program instructions to receive a request for an available parking spot;
program instructions to identify a driver desired location and set of vehicle information;
program instructions to manipulating a map on a user interface with a set of parking spots based on the driver desired location, the vehicle information, wherein the set of parking spots are parking spots which are available for the driver;
program instructions to receiving a selection of a parking spot;
program instructions to initiate the exchange of the selected parking spot, wherein a set of information is exchanged between the driver and a parked driver; and
program instructions to process the exchange and approve that the driver has successful parked their vehicle in the parking spot, wherein the money is exchanged and updating the set of parking spots.

16. The system of claim 15, further comprising monitoring the driver as they travel to the selected parking spot, wherein the time to arrival is provided to the parked driver.

17. The system of claim 15, providing visual images in a user interface to the driver of the parked driver's vehicle.

18. The system of claim 15, identifying that the driver is traveling away from the selected parking spot, and wherein the exchange is cancelled.

19. The system of claim 15, collecting data that the parked driver has exited the selected parking spot and that the driver has entered the parking spot.

20. The system of claim 15, manipulating a map based on the proximity to the selected spot the driver is.
